(19) United States
(12) Patent Application Publication
(10) Pub. No.: US 2018/0056745 A1
(43) Pub. Date: Mar. 1, 2018

(54) Methods And Systems To Calculate And Store GPS Coordinates Of Location-Based Features

(71) Applicant: GM GLOBAL TECHNOLOGY OPERATIONS LLC, Detroit, MI (US)

(72) Inventors: Brian K. Saylor, South Lyon, MI (US); Robert G. Izak, Dryden, MI (US)

(21) Appl. No.: 15/247,993

(22) Filed: Aug. 26, 2016

(51) Int. Cl. B60G 17/0165; G01C 21/36; B60K 31/00

(52) U.S. Cl. CPC B60G 17/0165; G01C 21/3664; B60K 31/0008; B60K 2031/0016; B60K 2350/1016; B60G 2600/182; B60G 2400/204; B60G 2400/90; B60G 2400/821; B60G 2800/162; B60G 2400/252

(57) ABSTRACT

A method to determine and store a location of a ground feature along a route of travel of a vehicle is disclosed. The method includes receiving a user input commanding a change to a vehicle suspension system setting; receiving first location data corresponding to a vehicle location at a time of receipt of the user input; receiving sensor data corresponding to at least one vehicle characteristic from at least one vehicle sensor; calculating a feature location based on the at least one vehicle characteristic; and storing the feature location. In response to a predicted path of the vehicle passing within a threshold distance of the feature location during a subsequent drive cycle, the actuator may be automatically controlled to change the vehicle suspension setting from a first setting to a second setting.

### INTRODUCTION

The present invention relates generally to the field of vehicles and, more specifically, to methods and systems for calculating and storing GPS coordinates for location-based features along a path of travel of the vehicle.

Vehicles with low ground clearance, such as sports cars, often encounter road characteristics that are not compatible with the vehicles' low ride height. These characteristics include features such as speed bumps, steep roads or driveways, or parking garage ramps. Some vehicles are equipped with active vehicle suspension systems that control the vertical movement of the vehicle body relative to the wheels with an onboard system of actuators configured to raise and lower the body independently at each wheel upon receipt of user input. When the operator chooses to command the suspension change, the feature is usually in front of the vehicle along the vehicle's projected path of travel.

The operator may want to save the GPS coordinates of the identified ground feature for future repeated use, especially for features located in frequently traveled areas. If the operator chooses to store the location data corresponding to the location where the operator requested the suspension change, the location where the operator commanded the change is not aligned with the actual obstacle or reason for the requested change.

### SUMMARY

Embodiments according to the present disclosure provide a number of advantages. For example, embodiments according to the present disclosure enable calculation of a point in space to establish a location marking a ground feature that may be stored, monitored, and detected by the vehicle approaching the feature from either direction. Additionally, a radius or distance extending from the stored location can establish a threshold distance from the stored location. If the vehicle passes within the threshold distance to the stored location, an onboard controller can initiate a change to a suspension system setting to enable timely vehicle suspension adjustments, such as adjusting the ride height, for any direction of approach to the stored location. Additionally, storing the location data corresponding to the location of the requested suspension change is useful as a suspension change trigger point only for travel in one direction. By predicting and calculating a point or location ahead of the vehicle along the vehicle's projected path of travel, the calculated point is more valuable to the operator for repeated future travel to that location. Embodiments according to the present disclosure may thus provide more robust feature identification, particularly important for ground based vehicles, increasing customer satisfaction.

In one aspect, a method to determine and store a location of a ground feature along a route of travel of a vehicle having a vehicle suspension system is disclosed. The method includes the steps of providing the vehicle with a user interface and a controller in electronic communication with the user interface; receiving, by the controller, a user input to the user interface commanding a change to a vehicle suspension system setting; receiving, by the controller, first location data corresponding to a vehicle location at a time of receipt of the user input; receiving, by the controller, sensor data corresponding to at least one vehicle characteristic from at least one vehicle sensor; calculating, by the controller, a feature location based on the at least one vehicle characteristic; and storing, by the controller, the feature location in a non-transient computer-readable data medium.

In some aspects, the method further includes providing the vehicle with an actuator configured to control the vehicle suspension system; and in response to the user input, controlling, by the controller, the actuator to change the vehicle suspension system setting; and in response to a predicted path of the vehicle passing within a threshold distance of the feature location during a subsequent drive cycle, automatically controlling, by the controller, the actuator to change the vehicle suspension setting from a first setting to a second setting.

In some aspects, the method further includes receiving, by the controller, second location data after a predetermined time period has elapsed following receipt of the user input. In some aspects, the method further includes calculating, by the controller, a distance to the ground feature from the vehicle location based on the at least one vehicle characteristic. In some aspects, the vehicle characteristic includes one or more of a vertical wheel displacement, a vehicle speed, and a vehicle heading. In some aspects, the method further includes receiving, by the controller, vertical displacement information and receiving, by the controller, third location data at a time of receipt of the displacement information. In some aspects, the method further includes calculating, by the controller, a distance to the ground feature from the vehicle location based on the vehicle heading and the vehicle speed.

In another aspect, an automotive vehicle includes a vehicle body and a plurality of wheels coupled to the vehicle body; a suspension control system selectively operable according to a first suspension system setting and a second suspension system setting; an actuator configured to control the suspension control system; at least one vehicle sensor; and a controller in communication with the actuator, the controller configured to receive a user input commanding a change from the first suspension system setting to the second suspension system setting; receive data corresponding to at least one vehicle characteristic from the at least one vehicle sensor; calculate a feature location of a ground feature based on the at least one vehicle characteristic; store the feature location in a non-transient computer-readable data medium; and in response to a predicted vehicle path passing within a threshold distance of the feature location during a subsequent drive cycle, automatically control the actuator to change the suspension control system from the first suspension system setting to the second suspension setting.

In some aspects, the controller is further configured to monitor a vehicle location with respect to the stored feature location. In some aspects, the controller is further configured to receive feature location data corresponding to the feature location after a predetermined time period has elapsed following receipt of the user input. In some aspects, the vehicle characteristic includes one or more of a vertical wheel displacement of one or more of the plurality of wheels, a vehicle speed, and a vehicle heading.

In some aspects, the controller is further configured to receive first location data corresponding to a vehicle location at a time of receipt of the user input and calculate a distance to the ground feature from the vehicle location based on the vehicle speed and the vehicle heading. In some aspects, the controller is further configured to receive vertical wheel displacement information and receive feature location data corresponding to the feature location at the time of receipt of the displacement information.

In yet another aspect, a system for determining a location of a ground feature located along a route of travel of a vehicle and storing the location of the ground feature, includes an actuator configured to control a vehicle suspension system, the vehicle suspension system selectively operable according to a first suspension system setting and a second suspension system setting; at least one vehicle sensor configured to measure at least one vehicle characteristic; and a controller in communication with the actuator and the at least one vehicle sensor, the controller configured to determine the location of the ground feature based on the at least one vehicle characteristic and automatically control the actuator to change a vehicle suspension system setting from the first suspension system setting to the second suspension setting in response to a vehicle location passing within a threshold distance of the location of the ground feature.

In some aspects, the vehicle sensor includes one or more of an accelerometer, a vehicle speed sensor, and a heading sensor. In some aspects, the vehicle characteristic includes one or more of a vertical wheel displacement, a vehicle speed, and a vehicle heading. In some aspects, the system further includes a vehicle navigation system in communication with the controller. In some aspects, the controller is further configured to receive a vehicle location from the navigation system and calculate a distance between the vehicle location and the location of the ground feature based on the vehicle speed and the vehicle heading.

The above advantages and other advantages and features of the present disclosure will be apparent from the following detailed description of exemplary embodiments when taken in connection with the accompanying drawings.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment.

FIG. 2 is a schematic diagram of a vehicle approaching a location-based ground feature, according to an embodiment.

FIG. 3 is a schematic diagram of a controller of the vehicle shown in FIG. 1, according to an embodiment.

FIG. 4 is a flow chart of a method to calculate and store GPS coordinates of a location-based feature using a known vehicle heading, according to an embodiment.

FIG. 5 is a flow chart of a method to calculate and store GPS coordinates of a location-based feature using a predetermined elapsed time, according to another embodiment.

FIG. 6 is a flow chart of a method to calculate and store GPS coordinates of a location-based feature using an accelerometer configured to detect vertical displacement, according to another embodiment.

FIG. 7 is a flow chart of a method to monitor the GPS coordinates of a vehicle with respect to a stored point indicating location-based feature, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

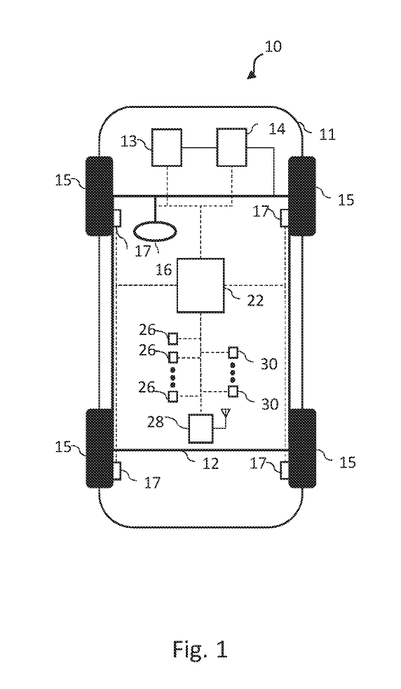

FIG. 1 schematically illustrates an automotive vehicle 10 according to the present disclosure. The vehicle 10 generally includes a body 11, a chassis 12, and wheels 15. The body 11 is arranged on the chassis 12 and substantially encloses the other components of the vehicle 10. The body 11 and chassis 12 may jointly form a frame. The wheels 15 are each rotationally coupled to the chassis 12 near a respective corner of the body 11. The vehicle 12 is depicted in the illustrated embodiment as a passenger car, but it should be appreciated that any other vehicle including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 includes a vehicle suspension system including suspension components 17 configured to raise and lower the body 11 and/or the chassis 12 relative to the ground. In some embodiments, the vehicle suspension system has a raised or lifted setting and a lowered or normal setting. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems.

The vehicle 10 additionally includes a steering system 16. While depicted as including a steering wheel and steering column for illustrative purposes, in some embodiments, the steering system 16 may not include a steering wheel. In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver.

With further reference to FIG. 1, the vehicle 10 also includes a plurality of sensors 26 configured to measure and capture data on one or more vehicle characteristics, including but not limited to vehicle speed, vertical wheel displacement, and vehicle heading. In the illustrated embodiment, the sensors 26 include, but are not limited to, an accelerometer, a speed sensor, a heading sensor, or other sensors that sense observable conditions of the vehicle or the environment surrounding the vehicle and may include RADAR, LIDAR, optical cameras, thermal cameras, ultrasonic sensors, and/or additional sensors as appropriate. The vehicle 10 also includes a plurality of actuators 30 configured to receive control commands to control steering, shifting, throttle, braking, suspension dynamics, or other aspects of the vehicle 10, as discussed in greater detail below.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

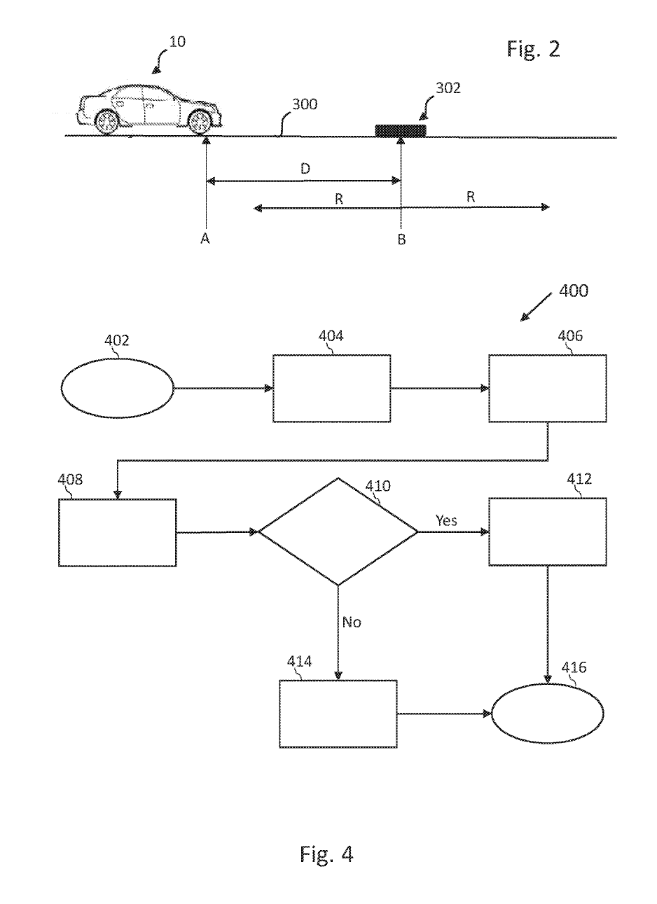

FIG. 2 schematically illustrates the vehicle 10 traveling along a road surface 300 and approaching a ground feature 302. The ground feature 302 may be any type of road characteristic, such as a ramp, speed bump, pothole, or other feature that could be difficult for a low ground clearance vehicle to navigate. At point A, the user may detect the upcoming ground feature 302 and command a suspension dynamics change by manipulating a user interface such as, for example, pressing a button or toggling a switch. As discussed in greater detail below, the GPS coordinates of the location at point A are saved and used to calculate an actual or predicted location of the ground feature 302, shown as point B in FIG. 2. In some embodiments, a distance D from point A may be used to calculate the location of the ground feature 302 at point B. In some embodiments, a radius R is determined from the calculated location of the ground feature 302 to establish an area surrounding the feature. In some embodiments, the radius R may define a circular 2D area. In other embodiments, other projecting envelopes including the feature 302 could be calculated, such as a cubic envelope, conical envelope, hemispherical, or spherical envelope. Each projecting envelope is centered on the location of the ground feature 302 and provides a threshold to initiate a suspension dynamics change in advance of the vehicle 10 reaching the location of the ground feature 302.

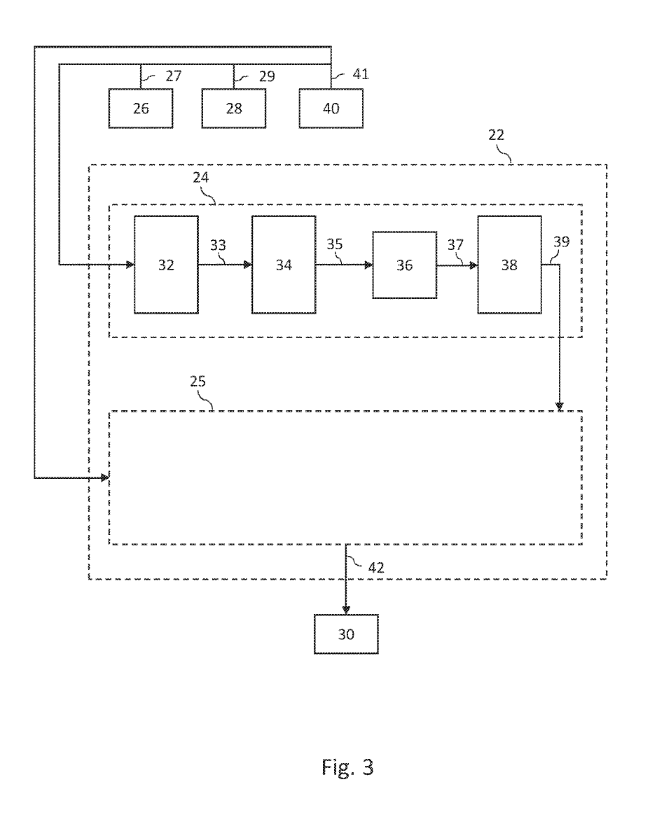

With reference to FIG. 3, the controller 22 includes a feature locating system 24 for calculating the location of a ground feature, illustrated as point B in FIG. 2. In an exemplary embodiment, the feature locating system 24 is configured to receive information from the plurality of sensors 26 and the navigation system 28, analyze the sensor and navigation input, determine a location of a ground feature located along a path of travel of the vehicle 10, and optionally store the location of the ground feature for further use by the feature locating system 24. Additionally, the controller 22 includes a suspension control system 25 configured to control the suspension components 17 configured to raise and lower the body 11 and/or the chassis 12 relative to the ground in response to receiving a signal from the feature locating system 24 indicating that the vehicle has passed within a threshold distance to a stored ground feature location, as discussed in greater detail below.

The feature locating system 24 includes a sensor fusion module 32 for determining the presence and location of detected features in the vicinity of the vehicle 10 and for receiving input on vehicle characteristics, such as vehicle speed, vehicle heading, wheel displacement or other vehicle characteristics. The sensor fusion module 32 is configured to receive input 27 from the plurality of sensors, such as the sensors 26 illustrated in FIG. 1. The sensor fusion module 32 is also configured to receive user input 41 from a user input device or user interface 40. The user input device 40 includes a button, dial, switch or other input device that can be manipulated by the user to indicate a desired setting change for the vehicle suspension system including, for example and without limitation, a change in vehicle ride height due to an upcoming ground feature identified by the user. Additionally, the sensor fusion module 32 receives navigation data 29 including longitude, latitude, and elevation information (e.g., GPS coordinates) from the navigation system 28.

The sensor fusion module 32 processes and synthesizes the inputs from the variety of sensors 26, the navigation system 28, and the user input device 40 and generates a sensor fusion output 33. The sensor fusion output 33 includes various calculated parameters including, but not limited to, a location of the vehicle at a time when the user input 41 is received, shown as point A in FIG. 2.

With continued reference to FIG. 3, the feature locating system 24 also include a calculation module 34 for determining an actual or predicted location of the ground feature, shown as point B in FIG. 2. The location of the ground feature at point B is typically ahead of the vehicle 10 along the route of travel. The calculation module 34 processes and synthesizes the sensor fusion output 33 to calculate the location of the ground feature at point B and generates a calculation output 35. In some embodiments, the calculation module 34 uses one or more parameters to calculate the calculation output 35. The parameters used in the location calculation include, but are not limited to, a known heading as determined by a heading sensor of the plurality of sensors 26, an elapsed time since receipt of the user input 41, the vehicle speed as registered by a speed sensor of the plurality of sensors 26, a vertical displacement of the wheel and/or chassis as determined by an accelerometer of the plurality of sensors 26, and a known location of the vehicle at the time of receipt of the user input 41.

With continued reference to FIG. 3, the feature locating system 24 includes a non-transient computer-readable data medium such as storage module 36 configured to store acquired location data and calculated data, including, but not limited to, the location of the vehicle at the time of receipt of the user input 41 (shown as point A in FIG. 2), a calculated distance to the ground feature (shown as distance D in FIG. 2), an elapsed time since receipt of the user input 41, and the location of the ground feature (shown as point B in FIG. 2). The monitoring module 38 accesses the stored data 37 and monitors the location of the vehicle 10 relative to the stored location of the ground feature. Upon returning to a predetermined vicinity of or distance to the location of the ground feature, the feature locating system 24 initiates a specific function, such as altering suspension dynamics, including, for example and without limitation, raising the vehicle ride height, before the vehicle arrives at the stored location.

Calculation of a point in space ahead of the vehicle can be more valuable to locate a ground feature than the GPS location of the vehicle at the moment of the user's request to alter suspension dynamics. Calculation of the location of the feature ahead of the vehicle and storing the calculated point allows the suspension system to complete its action prior to the location where the change is desired. Additionally, the calculated and stored point is closer to the actual obstacle or reason for the suspension change. When the vehicle returns to the stored GPS location, activation of the suspension change may be based upon the vehicle speed and direction of approach to the stored location in such a way as to simulate a driver requesting the change. Furthermore, the stored point can be used to trigger the suspension change when the vehicle approaches the stored GPS location from another direction.

In some embodiments, the calculation module 34 also calculates a radius surrounding the ground feature. As shown in FIG. 2, the radius R illustrates a radius surrounding the ground feature at point B. The radius R establishes an area surrounding the ground feature. When the vehicle 10 enters the area surrounding the ground feature, the monitoring module 38 generates a proximity signal 39.

As shown in FIG. 3, the controller 22 also includes the suspension control system 25 configured to analyze the proximity signal 39 and generate a control output 42. The control output 42 includes a set of actuator commands to achieve a suspension dynamics change commanded by the user or instructed as determined by the monitoring module 38 due to proximity of the vehicle to the location of the ground feature. The control output 42 is communicated to actuators 30. In an exemplary embodiment, the actuators 30 include a steering control, a throttle control, and one or more suspension controls. The steering control may, for example, control the steering system 16 as illustrated in FIG. 1. The throttle control may, for example, control a propulsion system 12 as illustrated in FIG. 1. The suspension control may, for example, control suspension components 17, as illustrated in FIG. 1. When the vehicle 10 crosses the threshold of the area surrounding the feature by entering the area defined by the radius R, the monitoring module 38 can communicate a signal to the actuators 30 to initiate a change in a vehicle suspension system setting or initiate other vehicle characteristic changes, such as steering and speed corrections. Additionally, the monitoring module 38 can communicate a signal to the actuators 30 to initiate a change in a vehicle suspension system setting when the vehicle returns to the area of the location even if the vehicle approaches the feature location from a direction different from the original direction of approach.

As discussed above, various parameters such as the vehicle heading, the elapsed time since a commanded change to suspension system setting, or accelerometer data may be used to calculate the location of a ground feature. FIG. 4 is a flow chart of a method 400 illustrating the calculation of the location of a ground feature along a vehicle's projected path of travel using vehicle heading data, the vehicle speed, and a predetermined time interval. The vehicle heading data and the vehicle speed data are obtained from one or more of the sensors 26. The method 400 can be utilized in connection with the vehicle 10, the controller 22, the various modules of the feature locating system 24, and the suspension control system 25, in accordance with exemplary embodiments. The order of operation within the method 400 is not limited to the sequential execution as illustrated in FIG. 4, but may be performed in one or more varying orders as applicable and in accordance with the present disclosure.

As shown in FIG. 4, starting at 402, the method proceeds to step 404. At 404, the sensor fusion module 32 of the feature locating system 24 receives the user input 41 indicating that the user has commanded a change to a vehicle suspension system setting due to an upcoming ground feature along the vehicle's projected route of travel. The sensor fusion module 32 also receives the inputs 27 from the plurality of sensors 26 and the navigation data 29 indicating the longitude, latitude, and/or elevation of the location where the user commanded the suspension change (shown as point A in FIG. 2). Additionally, at 404, the GPS location at point A and the vehicle heading are recorded and stored in the storage module 36.

Next, at 406, the calculation module 34 of the feature locating system 24 uses the recorded vehicle heading, the vehicle speed acquired from one of the sensors 26, and a predetermined time interval to calculate a distance vector from the GPS location at point A. The distance vector indicates a projected location of the ground feature based on the current vehicle speed over the predetermined time interval. In some embodiments, the predetermined time interval is determined by the expected time to complete a suspension dynamics change for a given vehicle and may vary depending on the vehicle type or model. In some embodiments, the predetermined time interval may be less than 2 seconds, less than 3 seconds, less than 4 seconds, or less than 5 seconds. In some embodiments, the predetermined time interval may be between 1 and 5 seconds, between 2 and 4 seconds, or between 2 and 3 seconds. In some embodiments, the predetermined time interval may be approximately 2 seconds, approximately 2.3 seconds, approximately 2.5 seconds, approximately 2.7 seconds, approximately 3 seconds, approximately 3.3 seconds, or approximately 3.6 seconds.

In some embodiments, a vehicle suspension dynamics change, such as raising a vehicle ride height to a raised ride height setting, can be completed in a predetermined time interval of approximately 2-3 seconds after receipt of an initialization signal, such as a user input indicating a “raise” command. Calculation of the location of the ground feature, such as ground feature 302 shown in FIG. 2, is based on the distance the vehicle will travel along the known heading during the predetermined time interval at the current vehicle speed. At 408, the calculation module 34 uses the distance vector calculated at 406 and the stored location at the time of the user command (point A) to determine the location of the ground feature 302 at point B.

At 410, the feature locating system 24 prompts the user to indicate whether the calculated location of the ground feature should be stored for future use. As discussed above, storing the location of a ground feature in a frequently-traveled area allows the feature locating system 24 to monitor the vehicle's location relative to the stored point and initiate a vehicle characteristic change, such as a suspension system setting change, independent of the vehicle's direction of approach to the stored location. If the user indicates that the calculated location should be stored, the method 400 progresses to 412, the GPS coordinates of the calculated point are stored in the storage module 36, and the method 400 progresses to 416 and ends. Otherwise, if the user does not affirmatively choose to store the calculated location or affirmatively chooses not to store the calculated location, the method 400 progresses to 414, the calculated location is discarded, and the method 400 ends at 416.

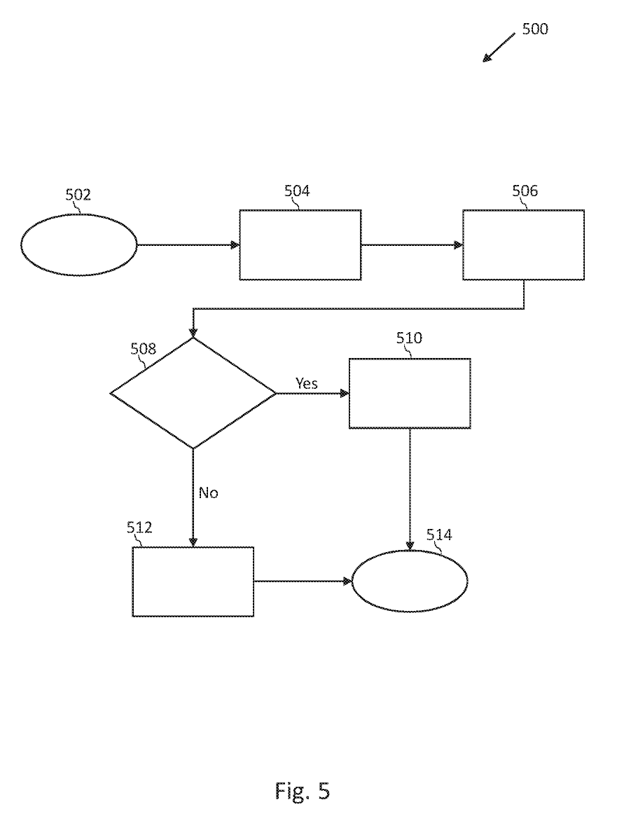

FIG. 5 is a flow chart of a method 500 illustrating the determination of the location of a ground feature along a vehicle's projected path of travel using a predetermined time interval. The method 500 can be utilized in connection with the vehicle 10, the controller 22, the various modules of the feature locating system 24, and the suspension control system 25, in accordance with exemplary embodiments. The order of operation within the method 500 is not limited to the sequential execution as illustrated in FIG. 5, but may be performed in one or more varying orders as applicable and in accordance with the present disclosure.

Starting at 502, the method 500 proceeds to 504. At 504, the sensor fusion module 32 of the feature locating system 24 receives the user input 41 indicating that the user has commanded a change to the vehicle's suspension dynamics by, for example, entering a “raise” command, due to an upcoming ground feature along the vehicle's projected route of travel. Also at 504, a timer is started to indicate an elapsed time since receipt of the commanded suspension dynamics change. In some embodiments, the predetermined time interval is determined by the expected time to complete the suspension dynamics change for a given vehicle and may vary depending on the vehicle type or model. In some embodiments, the predetermined time interval may be less than 2 seconds, less than 3 seconds, less than 4 seconds, or less than 5 seconds. In some embodiments, the predetermined time interval may be between 1 and 5 seconds, between 2 and 4 seconds, or between 2 and 3 seconds. In some embodiments, the predetermined time interval may be approximately 2 seconds, approximately 2.3 seconds, approximately 2.5 seconds, approximately 2.7 seconds, approximately 3 seconds, approximately 3.3 seconds, or approximately 3.6 seconds.

At 506, when the elapsed time equals the predetermined time interval, the feature locating system 24 acquires navigation data 29 from the navigation system 28 indicating the location of the vehicle, which is also the location of the ground feature, and records and stores the location data (e.g., GPS coordinates) in the storage module 36. Next, at 508, the feature locating system 24 prompts the user to indicate whether the feature location data should be stored for future use. As discussed above, storing the location of a ground feature in a frequently-traveled area allows the feature locating system 24 to monitor the vehicle's location relative to the stored point and initiate a vehicle characteristic change, such as changing a suspension system setting, independent of the vehicle's direction of approach to the stored location. If the user indicates that the feature location data should be stored, the method 500 progresses to 510, the GPS coordinates of the point are stored in the storage module 36, and the method 500 progresses to 514 and ends. Otherwise, if the user does not affirmatively choose to store the location data or affirmatively chooses not to store the feature location data, the method 500 progresses to 512, the location data is discarded, and the method 500 ends at 514.

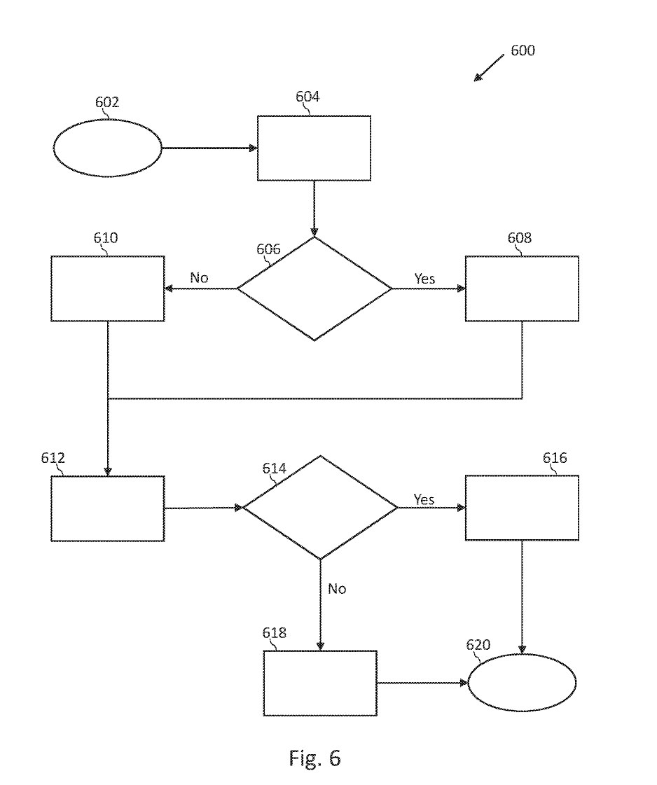

FIG. 6 illustrates a method 600 to determine the location of a ground feature along a vehicle's projected path of travel using a predetermined time interval or vertical displacement data from a vehicle accelerometer. The method 600 can be utilized in connection with the vehicle 10, the controller 22, the various modules of the feature locating system 24, and the suspension control system 25, in accordance with exemplary embodiments. The order of operation within the method 600 is not limited to the sequential execution as illustrated in FIG. 6, but may be performed in one or more varying orders as applicable and in accordance with the present disclosure.

Starting at 602, the method 600 proceeds to 604. At 604, the sensor fusion module 32 of the feature locating system 24 receives the user input 41 indicating that the user has commanded a change to the vehicle's suspension dynamics by, for example, entering a “raise” command, due to an upcoming ground feature along the vehicle's projected route of travel. Also at 604, a timer is started to indicate an elapsed time since receipt of the commanded suspension dynamics change. In some embodiments, the predetermined time interval is determined by the expected time to complete a suspension dynamics change for a given vehicle and may vary depending on the vehicle type or model. In some embodiments, the predetermined time interval may be less than 2 seconds, less than 3 seconds, less than 4 seconds, or less than 5 seconds. In some embodiments, the predetermined time interval may be between 1 and 5 seconds, between 2 and 4 seconds, or between 2 and 3 seconds. In some embodiments, the predetermined time interval may be approximately 2 seconds, approximately 2.3 seconds, approximately 2.5 seconds, approximately 2.7 seconds, approximately 3 seconds, approximately 3.3 seconds, or approximately 3.6 seconds.

At 606, when the elapsed time equals the predetermined time interval, the feature locating system 24 determines whether accelerometer data has been received from an accelerometer of the sensors 26, if the vehicle is equipped with an accelerometer. If the feature locating system 24 receives accelerometer data as part of the input 27, and the accelerometer data indicates a vertical wheel displacement indicating that the vehicle is passing over a feature affecting the vehicle suspension, such as a bump or ramp, the method proceeds to 608 and the feature locating system 24 acquires navigation data 29 associated with the location of the detected suspension change and records and stores the GPS navigation data as a stored feature location point at 612.

However, if the vehicle is not equipped with an accelerometer or the feature locating system 24 does not receive accelerometer data indicating a vertical wheel displacement, the method 600 proceeds to 610. At 610, the feature locating system 24 uses the elapsed time to determine the location of the ground feature. When the elapsed time equals the predetermined time interval, the feature locating system 24 acquires navigation data 29 from the navigation system 28 indicating the location of the vehicle. As discussed above, the predetermined time interval is determined by the expected time to complete a suspension dynamics change for a given vehicle and may vary depending on the vehicle type or model. In some embodiments, the predetermined time interval may be less than 2 seconds, less than 3 seconds, less than 4 seconds, or less than 5 seconds. In some embodiments, the predetermined time interval may be between 1 and 5 seconds, between 2 and 4 seconds, or between 2 and 3 seconds. In some embodiments, the predetermined time interval may be approximately 2 seconds, approximately 2.3 seconds, approximately 2.5 seconds, approximately 2.7 seconds, approximately 3 seconds, approximately 3.3 seconds, or approximately 3.6 seconds. The feature locating system 24 records the feature location data (e.g., GPS coordinates) at 612.

Next, at 614, the feature locating system 24 prompts the user to indicate whether the feature location data should be stored for future use. As discussed above, storing the location of a ground feature in a frequently-traveled area allows the feature locating system 24 to monitor the vehicle's location relative to the stored point and initiate a vehicle characteristic change, such as a suspension dynamics change, independent of the vehicle's direction of approach to the stored location. If the user indicates that the feature location data should be stored, the method 600 progresses to 616, the GPS coordinates of the point are stored in the storage module 36, and the method 600 progresses to 614 and ends. Otherwise, if the user does not affirmatively choose to store the location data or affirmatively chooses not to store the location data, the method 600 progresses to 618, the location data is discarded, and the method 600 ends at 620.

As discussed above with respect to method 600, the accelerometer data, from a vehicle equipped with an accelerometer, may be used to more precisely locate a ground feature. While the use of an accelerometer is discussed specifically with reference to the method 600, an accelerometer, and use of accelerometer data to more precisely locate a ground feature, may also be used with the methods 400 and 500, discussed above.

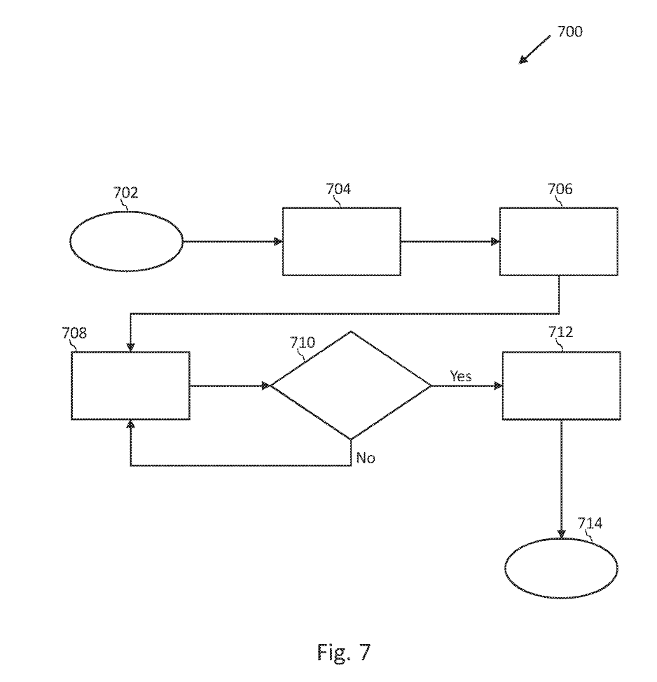

FIG. 7 illustrates a flow chart to monitor the GPS location of the vehicle with respect to a stored point indicating a ground feature. The method 700 can be utilized in connection with the vehicle 10, the controller 22, the various modules of the feature locating system 24, and the suspension control system 25, in accordance with exemplary embodiments. The order of operation within the method 700 is not limited to the sequential execution as illustrated in FIG. 7, but may be performed in one or more varying orders as applicable and in accordance with the present disclosure.

Starting at 702, the method 700 proceeds to 704. At 704, the feature locating system 24 calculates and/or records the navigation data (e.g., GPS coordinates) indicating the location of a ground feature according to any of the methods 400, 500, or 600 discussed above. At 706, the calculation module 34 of the feature locating system 24 calculates a threshold radius or distance from the feature location and uses the calculated radius to define an area surrounding the stored location of the feature. As discussed above, the area could be a 2D or 3D circular area or may be an elliptical, cubic, hemispherical, spherical, or other shaped area or envelope.

At 708, the monitoring module 38 monitors the location of the vehicle 10 relative to the stored location of the ground feature. The method proceeds to decision point 710 and the monitoring module 38 determines whether the vehicle 10 has entered the predetermined area surrounding the stored location. If the vehicle 10 is within the area defined by the threshold radius or within the threshold distance from the stored location, the method 700 proceeds to 712 and a signal, such as the proximity signal 39, is transmitted to the suspension control system 25 which generates the control output 42 to command one or more actuators to initiate a suspension change. The method 700 then returns to 708 to continue monitoring the location of the vehicle relative to the stored location of the ground feature. If, at 710, the vehicle is not within the area defined by the threshold radius or the vehicle is not within the threshold distance from the stored feature location, the method 700 returns to 708 to continue the monitoring step as discussed above.

It should be emphasized that many variations and modifications may be made to the embodiments described above, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Furthermore, as should be apparent, the features and attributes of the specific embodiments disclosed herein may be combined in different ways to form additional embodiments, all of which fall within the scope of the present disclosure.

Conditional language used herein, such as, among others, “can,” “could,” “might” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities; dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, hut should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method to determine and store a location of a ground feature along a route of travel of a vehicle having a vehicle suspension system, the method comprising:
providing the vehicle with a user interface and a controller in electronic communication with the user interface;
receiving, by the controller, a user input to the user interface commanding a change to a vehicle suspension system setting;
receiving, by the controller, first location data corresponding to a vehicle location at a time of receipt of the user input;
receiving, by the controller, sensor data corresponding to at least one vehicle characteristic from at least one vehicle sensor;
calculating, by the controller, a feature location based on the at least one vehicle characteristic; and
storing, by the controller, the feature location in a non-transient computer-readable data medium.

2. The method of claim 1, further comprising:
providing the vehicle with an actuator configured to control the vehicle suspension system; and
in response to the user input, controlling, by the controller, the actuator to change the vehicle suspension system setting; and
in response to a predicted path of the vehicle passing within a threshold distance of the feature location during a subsequent drive cycle, automatically controlling, by the controller, the actuator to change the vehicle suspension setting from a first setting to a second setting.

3. The method of claim 2, further comprising receiving, by the controller, second location data after a predetermined time period has elapsed following receipt of the user input.

4. The method of claim 2, further comprising calculating, by the controller, a distance to the ground feature from the vehicle location based on the at least one vehicle characteristic.

5. The method of claim 2, wherein the vehicle characteristic includes one or more of a vertical wheel displacement, a vehicle speed, and a vehicle heading.

6. The method of claim 5, further comprising receiving, by the controller, vertical displacement information and receiving, by the controller, third location data at a time of receipt of the displacement information.

7. The method of claim 5, further comprising calculating, by the controller, a distance to the ground feature from the vehicle location based on the vehicle heading and the vehicle speed.

8. An automotive vehicle, comprising:
a vehicle body and a plurality of wheels coupled to the vehicle body;
a suspension control system selectively operable according to a first suspension system setting and a second suspension system setting;
an actuator configured to control the suspension control system;
at least one vehicle sensor; and
a controller in communication with the actuator, the controller configured to
receive a user input commanding a change from the first suspension system setting to the second suspension system setting;
receive data corresponding to at least one vehicle characteristic from the at least one vehicle sensor;
calculate a feature location of a ground feature based on the at least one vehicle characteristic;
store the feature location in a non-transient computer-readable data medium; and
in response to a predicted vehicle path passing within a threshold distance of the feature location during a subsequent drive cycle, automatically control the actuator to change the suspension control system from the first suspension system setting to the second suspension setting.

9. The automotive vehicle of claim 8, wherein the controller is further configured to monitor a vehicle location with respect to the stored feature location.

10. The automotive vehicle of claim 8, wherein the controller is further configured to receive feature location data corresponding to the feature location after a predetermined time period has elapsed following receipt of the user input.

11. The automotive vehicle of claim 8, wherein the vehicle characteristic includes one or more of a vertical wheel displacement of one or more of the plurality of wheels, a vehicle speed, and a vehicle heading.

12. The automotive vehicle of claim 11, wherein the controller is further configured to receive first location data corresponding to a vehicle location at a time of receipt of the user input and calculate a distance to the ground feature from the vehicle location based on the vehicle speed and the vehicle heading.

13. The automotive vehicle of claim 11, wherein the controller is further configured to receive vertical wheel displacement information and receive feature location data corresponding to the feature location at the time of receipt of the displacement information.

14. A system for determining a location of a ground feature located along a route of travel of a vehicle and storing the location of the ground feature, comprising:
an actuator configured to control a vehicle suspension system, the vehicle suspension system selectively operable according to a first suspension system setting and a second suspension system setting;
at least one vehicle sensor configured to measure at least one vehicle characteristic; and
a controller in communication with the actuator and the at least one vehicle sensor, the controller configured to determine the location of the ground feature based on the at least one vehicle characteristic and automatically control the actuator to change a vehicle suspension system setting from the first suspension system setting to the second suspension setting in response to a vehicle location passing within a threshold distance of the location of the ground feature.

15. The system of claim 14, wherein the vehicle sensor includes one or more of an accelerometer, a vehicle speed sensor, and a heading sensor.

16. The system of claim 15, wherein the vehicle characteristic includes one or more of a vertical wheel displacement, a vehicle speed, and a vehicle heading.

17. The system of claim 16, further comprising a vehicle navigation system in communication with the controller.

18. The system of claim 17, wherein the controller is further configured to receive a vehicle location from the navigation system and calculate a distance between the vehicle location and the location of the ground feature based on the vehicle speed and the vehicle heading.
